(19) United States
(12) Patent Application Publication
(10) Pub. No.: US 2021/0094383 A1
(43) Pub. Date: Apr. 1, 2021

(54) THERMAL MANAGEMENT SYSTEMS AND METHODS FOR VEHICLES

(71) Applicant: Zoox, Inc., Foster City, CA (US)

(72) Inventors: Anup Madhav Vader, San Jose, CA (US); Paul Raymond Mueller, Hayward, CA (US); Jaime Andres Ocampo Villegas, Foster City, CA (US); Carter William McEathron, Redwood City, CA (US); Rahul Subramanian, San Francisco, CA (US)

(73) Assignee: Zoox, Inc.

(21) Appl. No.: 16/588,422

(22) Filed: Sep. 30, 2019

(51) Int. Cl. B60H 1/00

(52) U.S. Cl. CPC B60H 1/00278; B60H 1/00392

(57) ABSTRACT

A thermal management system may include a cabin heating and cooling system configured to control temperature in a vehicle cabin. The cabin heating and cooling system may include a cabin refrigerant circuit including a cabin refrigerant cycle configured to cool air. The thermal management system may also include an auxiliary heating and cooling system including an auxiliary coolant circuit, and the auxiliary coolant circuit may be in flow communication with an auxiliary device of the vehicle. The thermal management system may also include a chiller in flow communication with the cabin refrigerant circuit and the auxiliary coolant circuit. The chiller may be configured to exchange thermal energy between the cabin refrigerant circuit and the auxiliary coolant circuit. The thermal management system may also include a powertrain heating and cooling system including a powertrain coolant conduit configured to be in flow communication with an electric machine.

### BACKGROUND

A vehicle may include one or more electric motors for providing propulsion for the vehicle. In addition, a vehicle may include one or more batteries for supplying electric power to the one or more electric motors or other electrically-powered devices of the vehicle, such as instrumentation and lighting. The one or more electric motors may generate heat during operation, and the vehicle may include a cooling system for the electric motors. The vehicle may also include a heating ventilation and air conditioning (HVAC) system for controlling the temperature and humidity inside a passenger compartment of the vehicle for the comfort of vehicle occupants.

### BRIEF DESCRIPTION OF THE DRAWINGS

The detailed description is described with reference to the accompanying figures. The same reference numbers in different figures indicate similar or identical items.

FIG. 1 is a block diagram of an example vehicle and an example thermal management system for the vehicle.

FIG. 2 is a block diagram of an example vehicle and another example thermal management system for the vehicle.

FIG. 3 is a block diagram of an example vehicle and another example thermal management system for the vehicle.

FIG. 4 is a block diagram of an example vehicle and another example thermal management system for the vehicle.

FIG. 5 is a flow diagram of an example process for controlling temperature associated with different example systems of an example vehicle.

### DETAILED DESCRIPTION

As mentioned above, a vehicle may include one or more electric motors for providing propulsion for the vehicle, one or more batteries for supplying electric power to the one or more electric motors or other electrically-powered devices of the vehicle, such as computing devices, cameras, LIDAR sensors, RADAR sensors, lighting, instrumentation, audio systems, and/or, for semi- or fully-autonomous vehicles, one or more sensors and/or vehicle controllers configured to at least partially control maneuvering of the vehicle. The vehicle may also include a heating ventilation and air conditioning (HVAC) system for controlling the temperature and/or humidity inside an occupant compartment of the vehicle for the comfort of the occupant (e.g., a passenger).

This disclosure is generally directed to thermal management systems and related methods for controlling the temperature, flowrate, and/or humidity associated with the powertrain, a cabin of the vehicle, and/or one or more auxiliary devices, such as one or more batteries and/or other electrically-powered devices of the vehicle. In some examples, the thermal management system may include a powertrain heating and cooling system, a cabin heating and cooling system, and/or an auxiliary heating and cooling system for controlling the temperature, flowrate, and/or humidity associated with the powertrain, the cabin, and/or the auxiliary devices, respectively. In some examples of the systems and methods, thermal energy associated with one or more of the powertrain heating and cooling system, the cabin heating and cooling system, and/or the auxiliary heating and cooling system may be transferred between one another in order to provide a more efficient and/or more effective temperature control of the powertrain, the cabin, and/or the auxiliary devices. In some examples, the thermal management system may include one or more heat exchangers configured to transfer thermal energy between the powertrain heating and cooling system, the cabin heating and cooling system, and/or the auxiliary heating and cooling system, for example, as described herein. In at least some examples, this may result in more efficiently achieving and/or maintaining desired temperatures associated with the powertrain, cabin, and/or auxiliary devices.

This disclosure is generally directed to a vehicle including a thermal management system. In some examples, the thermal management system may include a powertrain heating and cooling system including a powertrain coolant circuit. The powertrain coolant circuit may include a powertrain coolant conduit configured to be in flow communication with an electric machine. The powertrain coolant circuit may also include an air-to-coolant heat exchanger in flow communication with the powertrain coolant conduit. The thermal management system may also include a cabin heating and cooling system configured to control temperature in the cabin. In some examples, the cabin heating and cooling system may include a cabin refrigerant circuit including a cabin refrigerant cycle configured to provide cooled air and a fan configured to communicate the cooled air into the cabin. The thermal management system may also include an auxiliary heating and cooling system including an auxiliary coolant circuit. In some examples, the auxiliary heating and cooling system may be configured to control temperature associated with at least one auxiliary device. In some examples, the auxiliary coolant circuit may include an auxiliary coolant conduit configured to be in flow communication with the at least one auxiliary device. In some examples, the at least one auxiliary device may include at least one of a battery or a computing device. In some examples, the thermal management system may further include a chiller in flow communication with the cabin refrigerant circuit and the auxiliary coolant circuit. The chiller, in some examples, may be configured to exchange thermal energy between the cabin refrigerant circuit and the auxiliary coolant circuit.

In some examples, the thermal management system may also include an evaporator in flow communication with the cabin refrigerant circuit and configured to heat refrigerant in the cabin refrigerant circuit. In some such examples, the evaporator may be in parallel with the chiller. In some examples, the chiller may include a liquid-to-liquid heat exchanger.

The thermal management system may also include, in some examples, a cooling core in flow communication with the auxiliary coolant circuit and configured to exchange thermal energy between the auxiliary coolant circuit and the cabin refrigerant circuit.

In some examples, the powertrain heating and cooling system may further include a valve in flow communication with the powertrain coolant circuit and the auxiliary coolant circuit, and the valve may be configured to provide flow communication between the powertrain coolant circuit and the auxiliary coolant circuit. In some examples, the powertrain heating and cooling system may include a coolant-to-coolant heat exchanger in flow communication with the powertrain coolant circuit and the auxiliary coolant circuit. The coolant-to-coolant heat exchanger may be configured to exchange thermal energy between the powertrain coolant circuit and the auxiliary coolant circuit. In some such examples, the thermal management system may also include a bypass conduit in flow communication with the auxiliary coolant circuit and configured to provide flow communication between the chiller and the cooling core bypassing the coolant-to-coolant heat exchanger.

Some examples of the thermal management system may include a thermal storage module associated with at least one of the cooling core or a battery of the vehicle. The thermal storage module may be configured to store thermal energy associated with the one or more of the cooling core or the battery. In some examples, the thermal storage module may include a phase-change material.

In some examples, the thermal management system may include a four-way valve in flow communication with the powertrain coolant circuit, the auxiliary coolant circuit, and the chiller. In some such examples, the four-way valve may be configured to control flow between the powertrain coolant circuit and the auxiliary coolant circuit, between the chiller and the auxiliary coolant circuit, and recirculation of flow from the auxiliary coolant circuit. In some examples, the four-way valve may facilitate more accurate temperature control of one or more batteries and/or one or more other auxiliary devices.

In some examples, the systems and methods described herein may result in more efficiently achieving and/or maintaining a desired temperature associated with the powertrain, cabin, and/or auxiliary devices, such as the batteries and computing devices. This may also result in a more compact, space-efficient design, which may provide design and/or packaging advantages related to other systems of the vehicle.

The techniques and systems described herein may be implemented in a number of ways. Example implementations are provided below with reference to the figures.

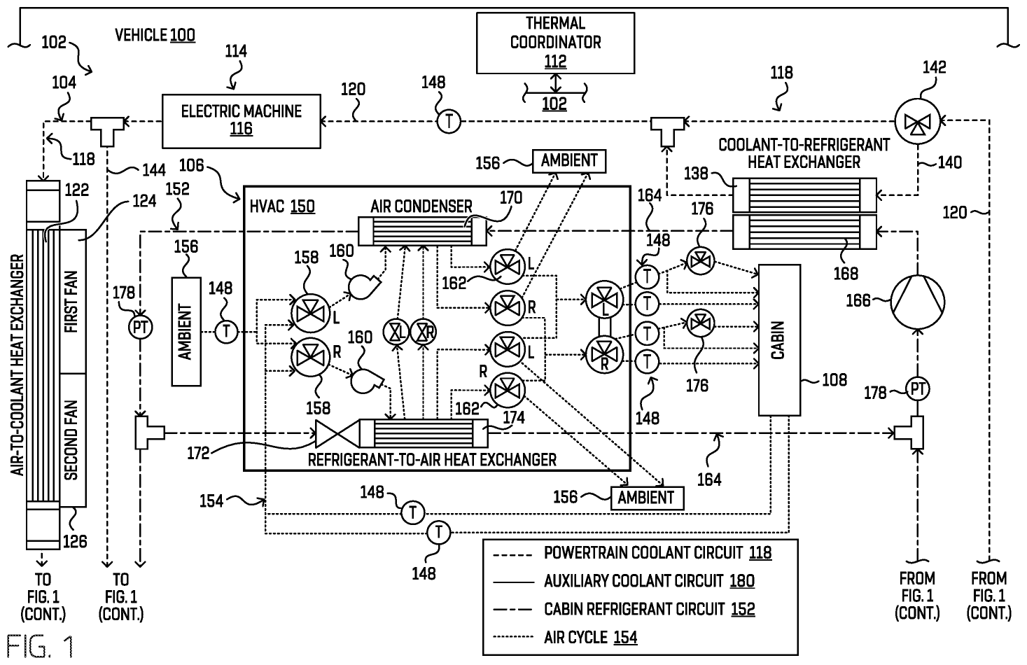

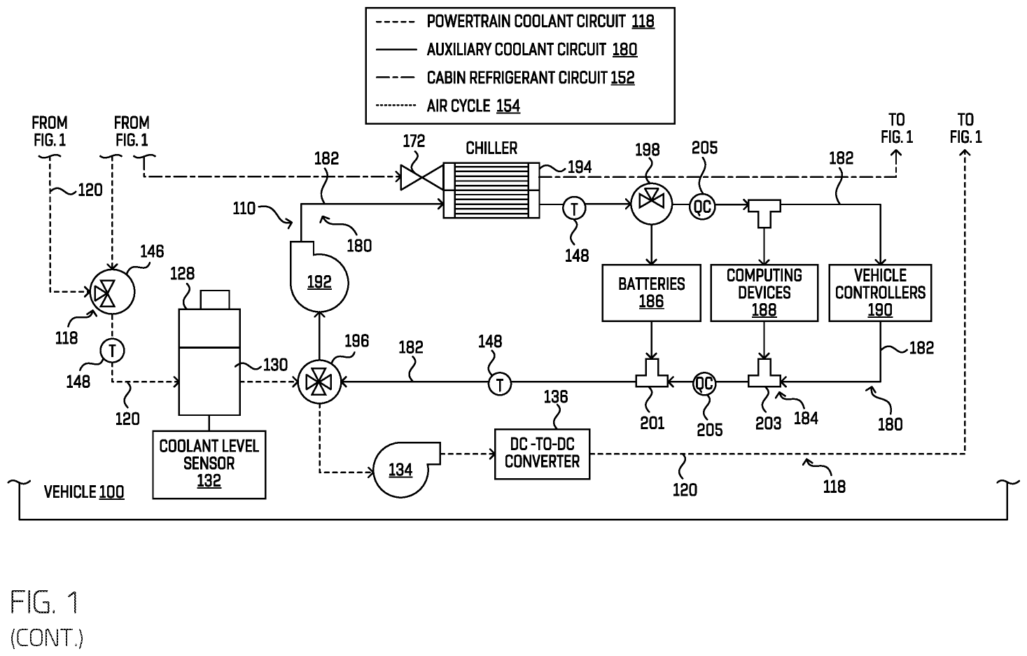

FIG. 1 is a block diagram of an example vehicle 100 and thermal management system 102, for example, for controlling distribution of thermal energy associated with operation of the vehicle 100. The vehicle 100 may be any type of vehicle, for example, a vehicle including one or more batteries and one or more electric machines configured to assist with, or provide power for, propulsion of the vehicle 100. For example, the vehicle 100 may be a non-hybrid or hybrid vehicle including one or more internal combustion engines, hydrogen power, any combination thereof, and/or any other suitable power sources, in addition to one or more electric motors to assist with propulsion of the vehicle 100. In some examples, the vehicle 100 may be an electric vehicle propelled primarily, or solely, by one or more electric motors. In some examples, the vehicle 100 may be controlled solely by a human operator located aboard the vehicle 100 and/or a human operator located remotely from the vehicle 100. In some examples, the vehicle 100 may be partially and/or fully autonomous. For example, the vehicle 100 may be a driverless vehicle, such as an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. In such examples, because the vehicle 100 may be configured to control all functions from start to completion of the trip, including all parking functions, it may not include a driver and/or controls for driving the vehicle 100, such as a steering wheel, an acceleration pedal, and/or a brake pedal. This is merely an example, and the systems and methods described herein may be incorporated into any ground-borne, airborne, or waterborne vehicle, including those ranging from vehicles that need to be manually controlled by a driver at all times to those that are partially- or fully-autonomously controlled.

The example vehicle 100 may be any configuration of vehicle, such as, for example, a van, a sport utility vehicle, a cross-over vehicle, a truck, a bus, an agricultural vehicle, or a construction vehicle. The vehicle 100 may include any number of wheels, tires, and/or tracks. In some examples, the vehicle 100 may be a bi-directional vehicle. For example, the vehicle 100 may have four-wheel steering and may operate generally with equal performance characteristics in all directions, for example, such that a first end of the vehicle 100 is the front end of the vehicle 100 when travelling in a first direction, and such that the first end becomes the rear end of the vehicle when traveling in the opposite, second direction. Similarly, a second end of the vehicle 100 may be the front end of the vehicle 100 when travelling in the second direction, and such that the second end becomes the rear end of the vehicle 100 when traveling in the opposite, first direction. These example characteristics may facilitate greater maneuverability, for example, in small spaces or crowded environments, such as parking lots and urban areas.

In the example shown in FIG. 1, the thermal management system 102 includes a powertrain heating and cooling system 104 configured to control temperature associated with a powertrain of the vehicle 100, a cabin heating and cooling system 106 configured to control temperature in a cabin 108 of the vehicle 100 configured to carry one or more passengers of the vehicle 100, and an auxiliary heating and cooling system 110 configured to control temperature associated with one or more auxiliary devices of the vehicle 100. In addition, the example thermal management system 102 shown in FIG. 1 also includes a thermal coordinator 112 configured to control operation and interaction between the powertrain heating and cooling system 104, the cabin heating and cooling system 106, and the auxiliary heating and cooling system 110. For example, as explained herein, the thermal coordinator 112 may be configured to receive one or more signals from sensors configured to generate signals indicative of the status of the vehicle 100 (e.g., operation of the various components of the vehicle 100, and/or the position, velocity, and/or acceleration of the vehicle 100), the ambient temperature and/or pressure of the environment in which the vehicle 100 is traveling, and/or the temperature and/or pressure associated with fluids and/or components in one or more of the powertrain heating and cooling system 104, the cabin heating and cooling system 106, or the auxiliary heating and cooling system 110. Based at least partially on the one or more signals, the thermal coordinator 112 may communicate with one or more of valves, one or more pumps, one or more compressors, one or more expansions valves, and/or other components of the powertrain heating and cooling system 104, the cabin heating and cooling system 106, or the auxiliary heating and cooling system 110, to control distribution of thermal energy among one or more of the powertrain heating and cooling system 104, the cabin heating and cooling system 106, or the auxiliary heating and cooling system 110. For example, some examples of the thermal management system 102 may be configured to exchange thermal energy between one or more of the powertrain heating and cooling system 104, the cabin heating and cooling system 106, or the auxiliary heating and cooling system 110 in order to improve the effectiveness and/or efficiency of operation of the vehicle 100 and/or the thermal management system 102.

As shown in FIG. 1, the vehicle 100 may include a powertrain 114, which, in some example, may include an electric machine 116 configured to provide and/or assist with propulsion of the vehicle 100. The electric machine 116, in some examples, may include one or more electric motors and/or one or more inverters. For example, the one or more electric motors may include one or more alternating current (AC) motors, and the one or more inverters may be configured to convert direct current (DC) to alternating current for supplying electric power to the one or more electric motors. DC motors are also contemplated.

During operation of the powertrain 114 and/or the electric machine 116, heat may be generated, and thus, it may be desirable to cool parts of the powertrain 114, including the electric machine 116, in order to prevent damage to the electric machine 116 and/or to improve the performance of the electric machine 116. The thermal management system 102, in some examples, may include a powertrain heating and cooling system 104 configured to at least partially control temperature associated with the powertrain 114, including the electric machine 116, for example, as shown in FIG. 1. The powertrain heating and cooling system 104 may include a powertrain coolant circuit 118 configured to contain powertrain coolant, such as, for example, polyethylene glycol and/or other known coolants. For example, the powertrain coolant circuit 118 may include a powertrain coolant conduit 120 configured to be in flow communication with the electric machine 116 and/or other components of the powertrain 114. For example, the powertrain coolant conduit 120 may be in flow communication with an air-to-coolant heat exchanger 122 configured to cool powertrain coolant in the powertrain coolant conduit 120, for example, as shown in FIG. 1. In some examples, the air-to-coolant heat exchanger 122 may include one or more radiators through which the powertrain coolant flows and exchanges heat with the surroundings, thereby cooling the powertrain coolant. In some examples, the powertrain heating and cooling system 104 may also include one or more cooling fans, such as, for example, electric fans (e.g., primary fan 124 and secondary fan 126) configured to enhance cooling of the powertrain coolant as it flows through the air-to-coolant heat exchanger 122.

As shown in FIG. 1, the powertrain heating and cooling system 104 may also include a coolant reservoir 128 configured to contain a supply 130 of the powertrain coolant, and in some examples, a coolant level sensor 132 configured to generate one or more signals indicative of the level of the supply 130 of the powertrain coolant. As shown in FIG. 1, the powertrain heating and cooling system 104 may also include one or more pumps 134 configured to pump the powertrain coolant through the powertrain coolant conduit 120 to cool the components associated with the powertrain 114. For example, the powertrain 114 may also include a direct current-to-direct current (DC-to-DC) converter 136 configured to supply power to the DC components of the vehicle 100, such as, for example, interior lighting, exterior lighting, computing devices, coolant pumps, etc.

In some examples, the powertrain heating and cooling system 104 may also include a coolant-to-refrigerant heat exchanger 138 (e.g., a liquid condenser) in flow communication with the powertrain coolant conduit 120. For example, as shown in FIG. 1, the powertrain coolant circuit 118 may include a first bypass conduit 140 and a first valve 142 (e.g., a coolant valve) in flow communication with the coolant-to-refrigerant heat exchanger 138. The first valve 142 may be controlled, for example, by the thermal coordinator 112, to selectively flow at least some of the powertrain coolant through the coolant-to-refrigerant heat exchanger 138 via the first bypass conduit 140, for example, to exchange thermal energy with the cabin heating and cooling system 106, as explained herein. For example, by exchanging thermal energy, powertrain coolant may be heated by heat removed from the refrigerant in the coolant-to-refrigerant heat exchanger 138, for example, when the powertrain is cooler than desired. If the powertrain coolant is cooler than the refrigerant in the coolant-to-refrigerant heat exchanger 138, the powertrain coolant may be used to assist with cooling the refrigerant in the coolant-to-refrigerant heat exchanger 138. In this example manner, the valve 142 may be controlled by the thermal coordinator 112 to increase the efficiency of the powertrain heating and cooling system and/or the cabin heating and cooling system.

Some examples of the powertrain coolant circuit 118 may also include a second bypass conduit 144 and a second valve 146 in flow communication with the electric machine 116. The second valve 146 may be controlled, for example, by the thermal coordinator 112, to selectively flow at least some of the powertrain coolant around the air-to-coolant heat exchanger 122, for example, so that heat in the powertrain coolant is not reduced by the air-to-coolant heat exchanger 122 as it flows back to the pump 134 of the powertrain coolant circuit 118. In this example, heat in the powertrain coolant may be at least partially preserved (rather than removed), for example, in order to be used by the cabin heating and cooling system 106 and/or the auxiliary heating and cooling system 110 to respectively increase the temperature inside the cabin 108 and/or to increase the temperature of one or more of the auxiliary devices, for example, when the ambient temperature is cooler than the air temperature desired inside the cabin 108 and/or associated with one of the auxiliary devices, for example, as explained herein.

In some examples, the powertrain coolant circuit 118 may include one or temperature sensors 148 (and/or one or more pressure sensors) configured to generate one or more signals indicative of the temperature (and/or pressure) of the powertrain coolant at one or more portions of the powertrain coolant circuit 118. Such signals may be communicated to the thermal coordinator 112, which may communicate with one or more of the control valves, one or more pumps, one or more blowers, one or more compressors, one or more expansions valves, and/or other components of the powertrain heating and cooling system 104, the cabin heating and cooling system 106, and/or the auxiliary heating and cooling system 110 to control distribution of thermal energy among one or more of the powertrain heating and cooling system 104, the cabin heating and cooling system 106, or the auxiliary heating and cooling system 110, for example, as explained herein. In some examples, communication between the thermal coordinator 112 and one or more other components of the thermal management system 102 may be communicated via hard-wired communication links and/or wireless communication links, according to known wired and/or wireless protocols.

As shown in FIG. 1, the cabin heating and cooling system 106 may be in flow communication with the cabin 108 of the vehicle 100 and may be configured to control temperature in the cabin 108. In some examples, the cabin heating and cooling system 106 may include a heating ventilation and air conditioning (HVAC) system 150 including a cabin refrigerant circuit 152 and an air cycle 154 configured to cool air in flow communication with the cabin 108. For example, as shown in FIG. 1, ambient air 156 may be drawn from the surrounding environment into the HVAC system 150, which may include one or more intake valves 158 providing selective flow communication with one or more blowers 160 configured to communicate the air drawn in through portions of the HVAC system 150 into the cabin 108 via one or more vents valves 162, which may be configured to selectively communicate air conditioned (e.g., cooled, heated, and/or dehumidified) by the HVAC system 150 into the cabin 108 and/or back out to the ambient air 156. In some examples, during heating of the cabin 108, ambient air 156 may be drawn from outside the cabin 108 across and/or through the refrigerant-to-air heat exchanger 174 and into the cabin 108, extracting heat back into the HVAC system 150 through the refrigerant-to-air heat exchanger 174, which thereby results in recovering that heat, and thereafter exhausting the resulting cooler air to the ambient air 156 (e.g., outside the cabin 108). Thus, some examples may result in circulation and recovery of heat from the cabin 108, thereby increasing the thermal efficiency of the system.

In the example shown, the cabin refrigerant circuit 152 of the HVAC system 150 includes cabin refrigerant conduit 164 providing flow communication between a compressor 166, a heat exchanger 168 (e.g., a liquid condenser), an air condenser 170, an expansion valve 172, and an refrigerant-to-air heat exchanger 174 (e.g., an evaporator) configured to perform a refrigeration cycle to cool and/or dehumidify air for supplying to the interior of the cabin 108. For example, at least a portion of the ambient air 156 may be communicated with the air condenser 170 and/or the refrigerant-to-air heat exchanger 174 via one or more of the blowers 160 to change the temperature and/or humidity of the ambient air 156, and thereafter the conditioned air may be communicated to the interior of the cabin 108 by control of one or more interior valves 176. In some examples, the heat exchanger 168 may be configured to exchange thermal energy with the coolant-to-refrigerant heat exchanger 138 of the powertrain coolant circuit 118. For example, thermal energy in the powertrain coolant circuit 118 may be selectively communicated to the coolant-to-refrigerant heat exchanger 138 via the first bypass conduit 140 to transfer thermal energy (e.g., heat) to the heat exchanger 168 to heat refrigerant in the cabin refrigerant circuit 152. For example, the thermal coordinator 112 may communicate with the first valve 142 to cause the first valve to operate to divert at least a portion of the powertrain coolant (e.g., heated via operation of the powertrain 114) into the first bypass conduit 140 and through the coolant-to-refrigerant heat exchanger 138 to exchange thermal energy with refrigerant in the cabin refrigerant circuit 152. As shown in FIG. 1, the cabin heating and cooling system 106 may include one or more temperature sensors 148 configured to generate signals indicative of the temperature in different portions of the cabin 108. Some examples may include one or more temperature and/or pressure sensors 178 in communication with the cabin refrigerant circuit 152 and configured to generate one or more signals indicative of temperature and/or pressure associated with portions of the cabin refrigerant circuit 152. Such signals may be communicated to the thermal coordinator 112, which may communicate with one or more of the valves, one or more pumps, one or more blowers, one or more compressors, one or more expansion valves, and/or other components of the powertrain heating and cooling system 104, the cabin heating and cooling system 106, and/or the auxiliary heating and cooling system 110 to control distribution of thermal energy among one or more of the powertrain heating and cooling system 104, the cabin heating and cooling system 106, or the auxiliary heating and cooling system 110, for example, as explained herein.

As shown in FIG. 1, the auxiliary heating and cooling system 110 includes an auxiliary coolant circuit 180 including an auxiliary coolant conduit 182 including coolant, such as, for example, ethylene glycol and/or other known coolants, and configured to be in flow communication with one or more auxiliary devices 184 of the vehicle 100. In some examples, the one or more auxiliary devices 184 may include one or more batteries 186 configured to store and supply electric power to the vehicle 100, one or more heat generating devices, such as, for example, computing devices 188 configured to control various systems of the vehicle 100, and/or one or more vehicle controllers 190 configured assist with, or fully control, operation of the vehicle 100 (e.g., maneuvering of an autonomous vehicle). It may be desirable to control the temperature of such auxiliary devices 184 during operation of the vehicle 100 (and/or during charging of the one or more batteries 186) in order to prevent damage to the auxiliary devices 184 and/or improve operation of the auxiliary devices 184. Though illustrated as three auxiliary devices, such a thermal coordination circuit, in some examples, may support any number of auxiliary devices in parallel with one another, as illustrated in FIG. 1.

In the example shown in FIG. 1, the auxiliary heating and cooling system 110 includes a pump 192 configured to flow auxiliary coolant through the auxiliary coolant conduit 182 to one or more of the auxiliary devices 184, and a chiller 194 (e.g., a coolant-to-refrigerant heat exchanger, for example, configured to cool coolant via cold refrigerant) in flow communication with the auxiliary coolant conduit 182 and configured to exchange thermal energy with the cabin refrigerant circuit 152. For example, the chiller 194 may include a liquid-to-liquid heat exchanger in selective flow communication with both the cabin refrigerant circuit 152 and the auxiliary coolant circuit 180, for example, such that thermal energy may be exchanged between the cabin refrigerant circuit 152 and the auxiliary coolant circuit 180. For example, to provide additional cooling for the auxiliary coolant, the auxiliary coolant may be passed through the chiller 194, where cool refrigerant may be used to cool the auxiliary coolant.

In the example shown in FIG. 1, the auxiliary coolant circuit 180 is in flow communication with a third valve 196 (e.g., a four-way valve) configured to selectively provide flow communication between the powertrain coolant circuit 118 and the auxiliary coolant circuit 180, for example, such that powertrain coolant flowing through the powertrain coolant circuit 118 may at least partially mix with the auxiliary coolant flowing through the auxiliary coolant circuit 180, thereby affecting the temperature of the auxiliary coolant and, in some examples, the temperature of the powertrain coolant. In some examples, the third valve 196 may be configured to provide flow communication, such that powertrain coolant from the powertrain coolant circuit 118 may flow, via operation of the third valve 196, into the auxiliary coolant circuit 180 and be drawn into the pump 192, which may pump the mixed powertrain coolant and auxiliary coolant into the chiller 194, where the mixed powertrain coolant and auxiliary coolant may exchange thermal energy with the refrigerant in the cabin refrigerant circuit 152. Thereafter, the mixture of powertrain coolant and auxiliary coolant may flow to a fourth valve 198 (e.g., a three-way valve), which may be configured to selectively provide flow communication to the one or more batteries 186 to substantially maintain a desired temperature of the one or more batteries 186. The powertrain coolant and auxiliary coolant flowing to the one or more batteries 186 may flow to a T-connector 201, back to the third valve 196, and thereafter flow through the auxiliary coolant circuit 180. The fourth valve 198 may also provide flow communication with the powertrain coolant and auxiliary coolant to one or more of the one or more heat generating devices, such as, for example, one or more computing devices 188, the one or more vehicle controllers 190, and/or the other auxiliary devices 184, which may be connected to the auxiliary coolant circuit 180 in series or parallel. For example, some examples of the auxiliary coolant circuit 180 may be configured to facilitate expansion of the auxiliary coolant circuit 180 to provide temperature control for additional auxiliary devices. In the example shown, after a portion of the powertrain coolant and the auxiliary coolant flow to the computing devices 188, the powertrain coolant and the auxiliary coolant may flow to a T-connector 203, back to the third valve 196, and thereafter flow through the auxiliary coolant circuit 180. After a portion of the powertrain coolant and the auxiliary coolant flow to the vehicle controllers 190 and/or other auxiliary devices 184, the powertrain coolant and the auxiliary coolant may flow back to the third valve 196, and thereafter flow through the auxiliary coolant circuit 180. As shown in FIG. 1, the auxiliary coolant circuit 180 may also include one or more temperature sensors 148 configured to generate one or more signals indicative of the temperature at various locations along the auxiliary coolant circuit 180, which may be communicated to the thermal coordinator 112. In some examples, such as shown in FIG. 1, the auxiliary coolant circuit 180 may include a pair of quick-disconnect couplings 205 in the auxiliary coolant conduit 182 between the one or more batteries 186 and the one or more computing devices 188, for example, to facilitate quickly removing and/or connecting the portion of the auxiliary coolant circuit 180 downstream of the one or more batteries 186.

In some examples, when the thermal coordinator 112 determines that powertrain coolant should not be introduced into the auxiliary coolant circuit 180, for example, when the auxiliary coolant has a temperature within a desired range of temperatures for controlling the temperatures of the auxiliary devices 184, then the third valve 196 will prevent flow communication between the powertrain coolant circuit 118 and the auxiliary coolant circuit 180. In such instances, powertrain coolant will flow through the third valve 196 and continue to flow through the powertrain coolant circuit 118 to control the temperature of the powertrain components. In some examples, this will continue until the thermal coordinator 112 determines that it is desirable to provide flow communication between the powertrain coolant circuit 118 and the auxiliary coolant circuit 180, at which time the thermal coordinator 112 will communicate with the third valve 196, such that the third valve 196 will operate to provide flow communication between the powertrain coolant circuit 118 and the auxiliary coolant circuit 180. For example, the thermal coordinator 112 may receive one or more temperature signals and/or pressure signals from the temperature sensors 148 and/or temperature and pressure sensors 178, and compare the temperatures and/or pressures against predetermined desired temperatures and pressures, and thereafter, control operation of the third valve 196 to substantially achieve and/or maintain the desired temperatures and pressures, thereby controlling mixing of powertrain coolant and auxiliary coolant flow.

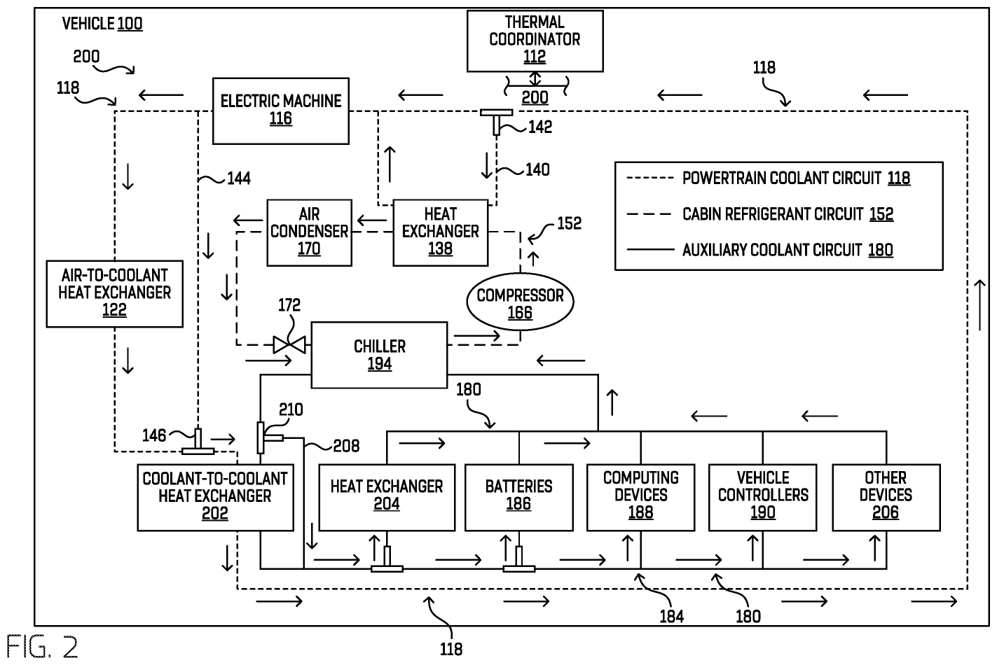

FIG. 2 is a block diagram of an example vehicle 100 and an example thermal management system 200 for the vehicle 100. The example thermal management system shown in FIG. 2 is similar to the example thermal management system 102 shown in FIG. 1, except that in at least some examples, the thermal management system 200 does not include the refrigerant-to-air heat exchanger 174 present in the thermal management system 102 shown in FIG. 1, and that the thermal management system 200 shown in FIG. 2 includes a coolant-to-coolant heat exchanger 202 in flow communication with the powertrain coolant circuit 118 and, selectively, the auxiliary coolant circuit 180. The example thermal management system 200 may also include a cooling core 204 (e.g., a coolant-to-air heat exchanger configured to cool air) in selective flow communication with the chiller 194 and the auxiliary coolant circuit 180. In addition, in contrast to some examples of the thermal management system 102 shown in FIG. 1, the powertrain coolant of the powertrain coolant circuit 118 shown in FIG. 2 is not in flow communication with the auxiliary coolant of the auxiliary coolant circuit 180, and thus, no mixing of the powertrain coolant and the auxiliary coolant occurs in at least some examples of the thermal management system 200 shown in FIG. 2.

In some examples, the coolant-to-coolant heat exchanger 202 may be configured to exchange thermal energy between the powertrain coolant circuit 118 and the auxiliary coolant circuit 180, which may result in increasing the temperature of the auxiliary coolant when the powertrain coolant is at a higher temperature than the auxiliary coolant, or in some situations, may result in lowering the auxiliary coolant temperature when the auxiliary coolant has a higher temperature than the powertrain coolant at the coolant-to-coolant heat exchanger 202.

Regarding the example cooling core 204, in some examples, the cooling core 204 may be used to provide cool air to the cabin. For example, the cooling core 204 may include a coolant-to-air heat exchanger having a core that may be cooled via the auxiliary coolant circuit 180 and a blower configured to communicate air across the core of the cooling core 204 and into the cabin 108 (FIG. 1), for example, as part of the air cycle. In some examples, the cooling core 204 may be used to heat air (or at least assist with heating the air) in the cabin 108. In some examples, the cooling core 204 may be heated, for example, via the auxiliary coolant circuit 180, for example, via thermal energy absorbed by the auxiliary coolant as it cools the one or more batteries 186, the one or more computing devices 188, the vehicle controllers 190, and/or other devices 206. In some examples, the powertrain coolant circuit 118 and the coolant-to-coolant heat exchanger 202 may supplement the thermal energy added to the cooling core 204, for example, when the powertrain coolant has a higher temperature than the auxiliary coolant, and the coolant-to-coolant heat exchanger 202 increases the temperature of the auxiliary coolant as the powertrain coolant and the auxiliary coolant both flow through the coolant-to-coolant heat exchanger 202. Thereafter, the auxiliary coolant heated by the powertrain coolant may be communicated to the cooling core 204, and a blower may be used to communicate air across the core of the cooling core (heated by the auxiliary coolant) and into the cabin 108 to thereby heat the air in the cabin 108.

The example thermal management system 200 shown in FIG. 2 may also include a bypass conduit 208 and a bypass valve 210 configured to allow the auxiliary coolant to bypass the coolant-to-coolant heat exchanger 202, for example, to avoid heating the auxiliary coolant with warmer powertrain coolant in order to supplement cooling of the cabin 108 via the chiller 194 (e.g., see FIG. 1) or to avoid cooling the auxiliary coolant with cooler powertrain coolant in order to heat (or supplement heating) of the cabin 108 via the cooling core 204. Although not shown in FIG. 2, an additional bypass conduit and bypass valve may be provided to provide a bypass between the exit of the end of the bypass conduit 208 and the conduit providing flow communication with the one or more batteries 186 to reduce (or substantially eliminate) the effects of the cooling core 204 on the temperature of the auxiliary coolant in communication with the one or more batteries 186, the one or more computing devices 188, the one or more vehicle controllers 190, and/or the other devices 206. This may facilitate assisting with achieving and/or maintaining a desired temperature of the batteries 186, the computing devices 188, the vehicle controllers 190, and/or the other devices 206 via the auxiliary coolant circuit 180, at least partially independent of the temperature associated with the cooling core 204.

In some examples, other than at least some of the above-mentioned example differences, the thermal management system 200 shown in FIG. 2 may include a powertrain coolant circuit 118, a cabin refrigerant circuit 152, and/or an auxiliary coolant circuit 180 at least similar to the powertrain coolant circuit 118, the cabin refrigerant circuit 152, and/or the auxiliary coolant circuit 180 shown in FIG. 1.

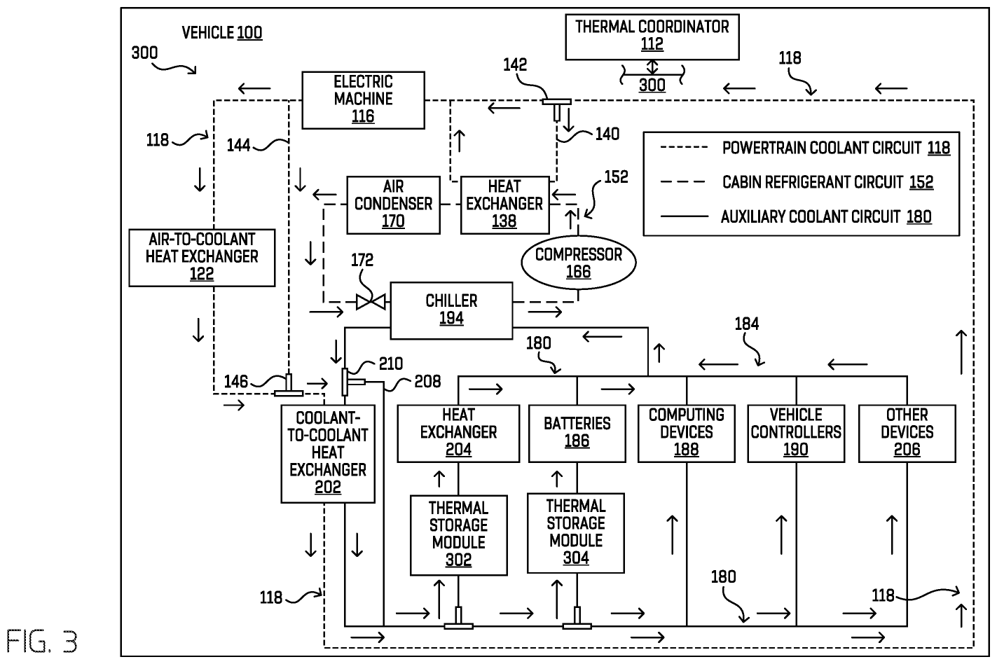

FIG. 3 is a block diagram of an example vehicle 100 and an example thermal management system 300 for the vehicle 100. The example thermal management system 300 shown in FIG. 3 is similar to the example thermal management system 200 shown in FIG. 2, except that in at least some examples, the thermal management system 300 may include a thermal storage module 302 associated with the cooling core 204 and/or a thermal storage module 304 associated with the one or more batteries 186. Although not shown in FIG. 3, additional thermal storage modules may be associated with other components of the thermal management system 300.

In some examples, the thermal storage module 302 and the thermal storage module 304 may be configured to store thermal energy associated with the cooling core 204 and/or the one or more batteries 186, respectively. For example, the thermal storage modules 302 and/or 304 may include a material configured to substantially maintain a temperature for a period of time, for example, to substantially maintain a temperature of an associated component without additional energy inputs, for example, from a compressor, pump, refrigerant cycle, or the like.

For example, the thermal storage modules 302 and/or 304 may include a phase-change material configured to substantially maintain a given temperature provided by the auxiliary coolant circuit 180, and in some instances, supplemented by the powertrain coolant circuit 118. The phase-change material may include organic phase-change materials, inorganic phase-change materials, hygroscopic phase-change materials, solid-solid phase-change materials, and/or the like. In some examples, the thermal storage module 302 may be able to substantially maintain the temperature associated with the cooling core 204, such that the thermal management system 300 may be able to continue to provide cooled air and/or warmed air to the cabin 108 while other parts of the vehicle 100 are not operational, such as, for example, the compressor 166 of the cabin refrigerant circuit 152. This may prevent undesirable noise and vibration resulting from repeated cycling of the compressor 166 when other components of the vehicle 100 are not operational. In some examples, the thermal storage module 304 may be able to substantially maintain the temperature associated with the one or more batteries 186, such that the thermal management system 300 may be able to continue to substantially maintain the temperature of the one or more batteries 186 while other parts of the vehicle 100 are not operational, such as, for example, one or more pumps associated with the thermal management system 300. In some examples, this may assist with substantially maintaining a specific temperature or temperature range of the one or more batteries 186, for example, during charging, which may occur while the vehicle 100 is otherwise not operational and which may generate relatively more heat than during other phases of operation of the vehicle 100. In some examples, the temperatures associated with the thermal storage modules 302 and/or 304 may be established and/or maintained while the vehicle 100 is receiving service or maintenance, for example, during charging of the one or more batteries 186. Thereafter, during operation of the vehicle 100, the thermal storage modules 302 and/or 304 may be used to assist with maintaining a desired temperature associated with the cooling core 204 and/or the one or more batteries 186.

In some examples, other than at least some of the above-mentioned example differences, the thermal management system 300 shown in FIG. 3 may include a powertrain coolant circuit 118, a cabin refrigerant circuit 152, and/or an auxiliary coolant circuit 180 at least similar to the powertrain coolant circuit 118, the cabin refrigerant circuit 152, and/or the auxiliary coolant circuit 180 shown in FIGS. 1 and 2.

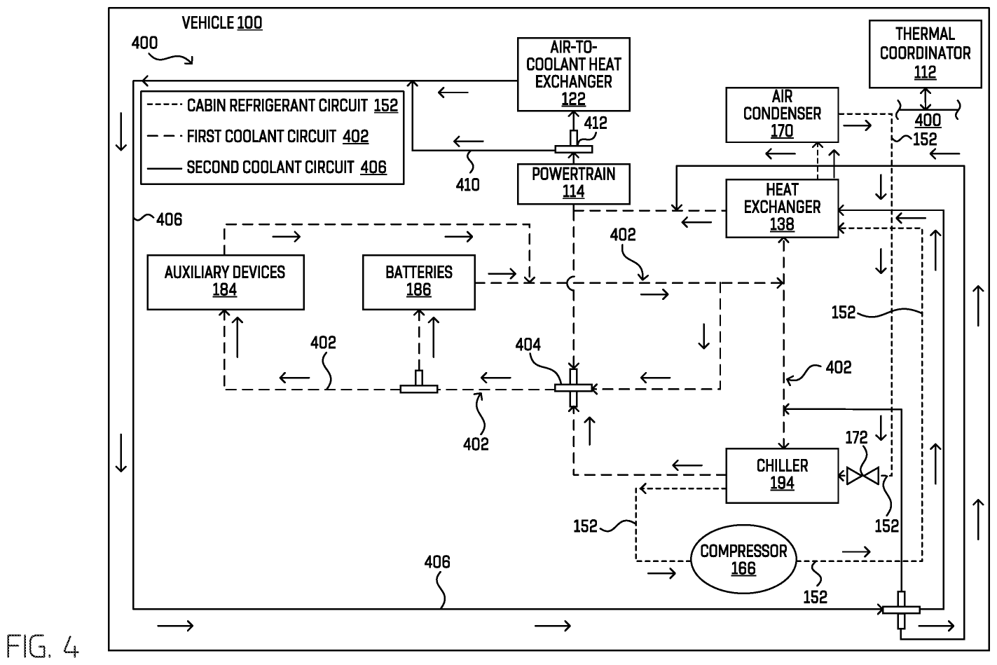

FIG. 4 is a block diagram of an example vehicle 100 and an example thermal management system 400 for the vehicle 100. In some examples, the thermal management system 400 may be effective in establishing and/or maintaining control of the temperature associated with the one or more batteries 186 within a smaller range of temperatures relative to the example thermal management systems 102, 200, and/or 300 shown in FIGS. 1-3. In the example shown in FIG. 4, the thermal management system 400 includes a cabin refrigerant circuit 152 including a compressor 166, followed by a coolant-to-refrigerant heat exchanger 138, followed by an air condenser 170 and a chiller 194, which may be a coolant-to-coolant heat exchanger, for example, as described with respect to FIGS. 1-3. The example thermal management system 400 shown in FIG. 4 also includes a first coolant circuit 402 (e.g., acting as an auxiliary coolant circuit) including a first coolant circuit conduit in flow communication with the coolant-to-refrigerant heat exchanger 138, followed by a four-way valve 404 configured to selectively provide flow communication with the one or more batteries 186 and the auxiliary devices 184 (e.g., computing devices, vehicle controllers, etc.). In the example shown, the one or more batteries 186 and the auxiliary devices 184 are provided in parallel downstream of the four-way valve 404. Flow communication associated with the one or more batteries 186 may exit and be in flow communication with the coolant-to-refrigerant heat exchanger 138, the chiller 194, or directly back to the four-way valve 404. Thus, the inputs to the four-way valve 404 may include flow directly from the one or more batteries 186, flow from the coolant-to-refrigerant heat exchanger 138, and/or flow from the chiller 194. The output of the four-way valve 404 may be the one or more batteries 186 and/or the auxiliary devices 184. Coolant in flow communication with the coolant-to-refrigerant heat exchanger 138 may be relatively warmer and may be used to warm the one or more batteries 186. Coolant in flow communication with the chiller 194 may be relatively cooler (e.g., than coolant from the coolant-to-refrigerant heat exchanger 138) and may be used to cool the one or more batteries 186, and coolant flowing directly from the one or more batteries 186 (and/or the auxiliary devices 184) may have a temperature being driven toward a desired temperature for the one or more batteries 186. The thermal management system 400 may include one or more temperature sensors and/or combination temperature and pressure sensors, for example, as described with the respect to FIG. 1, and the thermal coordinator 112 may communicate with the four-way valve 404 to control its operation based at least in part on signals received from the one or more temperature sensors and/or combination temperature and pressure sensors, and/or based on the desired temperature of the one or more batteries 186, such that the four-way valve 404 allows a combination of flows from the coolant-to-refrigerant heat exchanger 138, the chiller 194, and/or from the batteries 186 to establish and/or substantially maintain the one or more batteries 186 at the desired temperature. For example, the combination of flows may be based on flow rate ratios and respective temperatures to achieve a desired temperature.

In addition, the example thermal management system 400 shown in FIG. 4 also includes a second coolant circuit 406 (e.g., acting as a powertrain coolant circuit). The example second coolant circuit 406 is in flow communication with the powertrain 114 and includes an air-to-coolant heat exchanger 122 configured to cool the coolant in the second coolant circuit 406. In the example shown, the second coolant circuit 406 includes a bypass valve 408 and a bypass conduit 410 configured to selectively cause the second coolant circuit coolant to bypass the air-to-coolant heat exchanger 122, and flow to a four-way valve 412 configured to provide selective flow communication between the powertrain 114 (e.g., the electric machine 116 and associated components) and one or more of the first coolant circuit 402 upstream of the chiller 194, the coolant-to-refrigerant heat exchanger 138, or to the powertrain 114, bypassing the coolant-to-refrigerant heat exchanger 138.

In some examples, an additional heat exchanger (e.g., a coolant-to-coolant heat exchanger) may be provided between the chiller 194 and the four-way valve 404 and between the powertrain 114 and the four-way valve 404. In some such examples, the additional heat exchanger may facilitate transfer of thermal energy between the second coolant circuit 406 (e.g., acting as a powertrain coolant circuit) and the first coolant circuit 402 (e.g., acting as an auxiliary coolant circuit). In some such examples, a valve and bypass conduit may be provided to facilitate a selectable bypass around the additional heat exchanger.

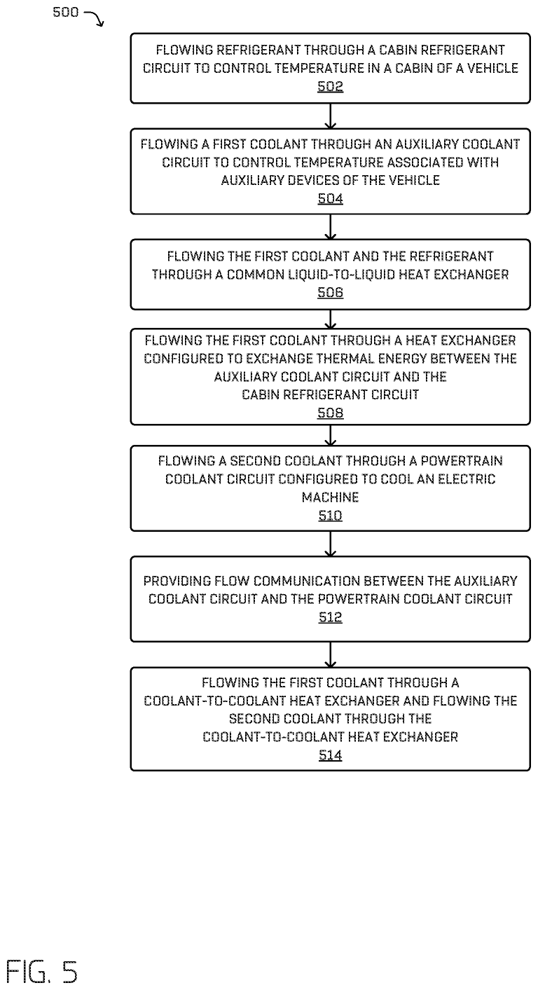

FIG. 5 is a flow diagram of an example process illustrated as a collection of blocks in a logical flow graph, which represent a sequence of operations that can be implemented in hardware, software, or a combination thereof. The order in which the operations are described is not intended to be construed as a limitation, and any number of the described blocks can be combined in any order and/or in parallel to implement the processes.

FIG. 5 is a flow diagram of an example process 500 for controlling temperature associated with different example systems of an example vehicle. At 502, the example process 500 may include flowing refrigerant through a cabin refrigerant circuit to control temperature in a cabin of a vehicle. For example, the cabin refrigerant circuit may include a refrigeration cycle that uses refrigerant to cool and/or dehumidify air supplied to the cabin of the vehicle.

The example process 500, at 504, may include flowing a first coolant through an auxiliary coolant circuit to control temperature associated with auxiliary devices of the vehicle. For example, the auxiliary coolant circuit may include one or more heat exchangers and/or one or more valves to control coolant flow through one or more conduits associated with the auxiliary coolant circuit. In some examples, the first coolant may include one or more known coolants, such as, for example, ethylene glycol or similar coolants. The auxiliary devices may include any devices associated with operation of the vehicle, such as, for example, one or more batteries configured to store and/or supply electric power for operation of one or more systems associated with operation of the vehicle. The auxiliary devices may also include one or more computer systems, one or more vehicle controllers configured to at least partially facilitate control of the vehicle and its related systems, and/or or other systems or devices, such as, for example, lighting, audio operations, etc.

At 506, the example process 500 may also include flowing the first coolant from the auxiliary coolant circuit and the refrigerant from the cabin refrigerant circuit through a common liquid-to-liquid heat exchanger, for example, to exchange thermal energy between the first coolant and the refrigerant. In some examples, this may facilitate exchanging thermal energy between the refrigerant and the first coolant. For example, if the refrigerant is at a temperature higher than the first coolant, a portion of the thermal energy associated with the refrigerant may be transferred to the first coolant, thereby cooling the refrigerant and heating the first coolant. In some examples, if the first coolant is at a temperature higher than the refrigerant, a portion of the thermal energy associated with the first coolant may be transferred to the refrigerant, thereby cooling the first coolant and heating the refrigerant. This may result in improving the efficiency and/or effectiveness of the cabin refrigerant circuit and/or the auxiliary coolant circuit.

The example process 500, at 508, may include flowing the first coolant through a cooling core configured to exchange thermal energy between the auxiliary coolant circuit and the cabin refrigerant circuit. For example, the cooling core may include an air-to-liquid heat exchanger through which the first coolant may flow. A blower may be used to communicate air (e.g., ambient air) across (over and/or through) the cooling core, thereby cooling or heating the air, depending on whether the first coolant is at a higher or lower temperature than the air. If the first coolant is at a lower temperature than the air, the air will be cooled as it is communicated across the cooling core, and the cooled air may be supplied to the vehicle cabin, for example, if the thermal management system is in the process of cooling the cabin and/or maintaining a temperature cooler than the ambient temperature of the environment in which the vehicle is located. This may also result in heating the first coolant, which may be useful for increasing the temperature of one or more of the auxiliary devices. If the first coolant is at a higher temperature than the air, the air will be heated as it is communicated across the cooling core, and the heated air may be supplied to the vehicle cabin, for example, if the thermal management system is in the process of heating the cabin and/or maintaining a temperature higher than the ambient temperature of the environment in which the vehicle is located. This may also result in cooling the first coolant, which may be useful for decreasing the temperature of one or more of the auxiliary devices. This example operation may result in improving the efficiency and/or effectiveness of the cabin refrigerant circuit and/or the auxiliary coolant circuit.

The example process 500, at 510, may also include flowing a second coolant through a powertrain coolant circuit configured to cool an electric machine. For example, the vehicle may include a powertrain including one or more electric motors configured to provide torque for propelling the vehicle and/or for assisting with propulsion of the vehicle (e.g., for a vehicle also including one or more non-electric-powered motors, such as, for example, an internal combustion engine). In some examples, the electric machine may include one or more inverters. The powertrain coolant circuit, in some examples, may include a second coolant configured to at least partially control the temperature associated with the powertrain. In some examples, the second coolant may include one or more known coolants, such as, for example, ethylene glycol or similar coolants. In some examples, the powertrain coolant circuit may include one or more heat exchangers configured to at least partially control the temperature of the second coolant. For example, the one or more heat exchangers may include an air-to-coolant heat exchanger configured to use ambient air to cool and/or substantially maintain the temperature associated with the second coolant in the powertrain coolant circuit. In some examples, the powertrain coolant circuit may also include one or more fans configured to communicate ambient air across (e.g., over and/or through) the one or more heat exchangers of the powertrain coolant circuit.

In some examples, the process 500 may include, at 512, providing flow communication between the auxiliary coolant circuit and the powertrain coolant circuit. In some examples, this may include at least partially mixing the first coolant and the second coolant with one another, for example, to provide a mixture of the first coolant and second coolant approaching or having a temperature that may be useful for controlling the temperature associated with the powertrain and/or the temperature associated with one or more of the auxiliary devices. For example, a thermal coordinator may receive temperature signals indicative of the powertrain coolant temperature and the auxiliary coolant temperature from temperature sensors, and, based at least in part on those signals, cause one or more valves to operate such that the powertrain coolant and the auxiliary coolant remain isolated from one another or partially mix with one another, for example, at flow rate ratios to achieve desired temperatures in the powertrain coolant circuit and/or the auxiliary coolant circuit.

In some such examples, at 514, the example process 500 may include flowing the first coolant through a coolant-to-coolant heat exchanger, and flowing the second coolant through the coolant-to-coolant heat exchanger, for example, such that thermal energy is exchanged between the powertrain coolant circuit and the auxiliary coolant circuit. For example, if the first coolant is at a lower temperature than the second coolant, the second coolant of the powertrain coolant circuit will be cooled as it passes through the coolant-to-coolant heat exchanger, and the cooled second coolant may be used to cool the one or more components of the powertrain, for example, if the thermal management system is in the process of cooling and/or maintaining the temperature of the powertrain. This may also result in heating the first coolant, which may be useful for increasing the temperature of one or more of the auxiliary devices. If the first coolant of the auxiliary coolant circuit is at a higher temperature than the second coolant, the second coolant will be heated as it is communicated through the coolant-to-coolant heat exchanger, and the heated second coolant may be supplied to the powertrain, for example, if the temperature of the powertrain is being increased, for example, to a temperature higher than the ambient temperature of the environment in which the vehicle is located during cold weather. This may also result in cooling the first coolant, which may be useful for decreasing the temperature of one or more of the auxiliary devices. This example operation may result in improving the efficiency and/or effectiveness of the powertrain coolant system and/or the auxiliary coolant circuit.

The subject matter described above is provided by way of illustration only and should not be construed as limiting. Furthermore, the claimed subject matter is not limited to implementations that solve any or all disadvantages noted in any part of this disclosure. Various modifications and changes may be made to the subject matter described herein without following the examples and applications illustrated and described, and without departing from the spirit and scope of the present invention, which is set forth in the following claims.

### EXAMPLE CLAUSES

A. An example vehicle comprising:

a powertrain heating and cooling system comprising a powertrain coolant circuit, the powertrain coolant circuit comprising:
a powertrain coolant conduit configured to be in flow communication with an electric machine; and
an air-to-coolant heat exchanger in flow communication with the powertrain coolant conduit;

a cabin heating and cooling system configured to control temperature in a cabin of the vehicle, the cabin heating and cooling system comprising:
a cabin refrigerant circuit comprising a cabin refrigerant cycle configured to provide cooled air; and
a fan configured to communicate the cooled air into the cabin;

an auxiliary heating and cooling system comprising an auxiliary coolant circuit, the auxiliary coolant circuit comprising:
an auxiliary coolant conduit configured to be in flow communication with an auxiliary device; and

a chiller in flow communication with the cabin refrigerant circuit and the auxiliary coolant circuit,

wherein the chiller is configured to exchange thermal energy between the cabin refrigerant circuit and the auxiliary coolant circuit.

B. The vehicle of example A, further comprising an evaporator in flow communication with the cabin refrigerant circuit and configured to cool refrigerant in the cabin refrigerant circuit, wherein the evaporator is in parallel with the chiller.

C. The vehicle of example A or example B, wherein the auxiliary heating and cooling system is configured to control temperature associated with at least one of a battery or a computing device.

D. The vehicle of any one of example A through example C, further comprising a valve in flow communication with the powertrain coolant circuit and the auxiliary coolant circuit, wherein the valve is configured to provide flow communication between the powertrain coolant circuit and the auxiliary coolant circuit.

E. The vehicle of any one of example A through example D, further comprising one or more of:

a coolant-to-air heat exchanger in flow communication with the auxiliary coolant circuit and configured to exchange thermal energy between the auxiliary coolant circuit and the cabin refrigerant circuit, or

a thermal storage module in flow communication with the auxiliary coolant circuit.

F. The vehicle of any one of example A through example E, further comprising a coolant-to-coolant heat exchanger in flow communication with the powertrain coolant circuit and the auxiliary coolant circuit and configured to exchange thermal energy between the powertrain coolant circuit and the auxiliary coolant circuit.

G. An example thermal management system comprising:

a cabin heating and cooling system configured to control temperature in a cabin of a vehicle, the cabin heating and cooling system comprising a cabin refrigerant circuit comprising a cabin refrigerant cycle configured to cool air in communication with the cabin;

an auxiliary heating and cooling system comprising an auxiliary coolant circuit, the auxiliary coolant circuit comprising an auxiliary coolant conduit in flow communication with an auxiliary device of the vehicle;

a chiller in flow communication with the cabin refrigerant circuit and the auxiliary coolant circuit;

a powertrain heating and cooling system comprising a powertrain coolant circuit, the powertrain coolant circuit comprising a powertrain coolant conduit configured to be in flow communication with a heat source; and

a coolant-to-coolant heat exchanger in flow communication with the powertrain coolant circuit and the auxiliary coolant circuit and configured to exchange thermal energy between the powertrain coolant circuit and the auxiliary coolant circuit,

wherein the chiller is configured to exchange thermal energy between the cabin refrigerant circuit and the auxiliary coolant circuit.

H. The thermal management system of example G, further comprising an evaporator in flow communication with the cabin refrigerant circuit and configured to exchange thermal energy between the cabin refrigerant circuit and the auxiliary coolant circuit.

I. The thermal management system of example G or example H, wherein the chiller comprises a coolant-to-refrigerant heat exchanger.

J. The thermal management system of any one of example G through example I, wherein the auxiliary heating and cooling system is configured to control temperature associated with a plurality of auxiliary devices in parallel flow communication with one another.

K. The thermal management system of any one of example G through example J, further comprising a valve in flow communication with the powertrain coolant circuit and the auxiliary coolant circuit, wherein the valve is configured to provide flow communication between the powertrain coolant circuit and the auxiliary coolant circuit based at least in part on at least one of temperature signals or pressures signals associated with at least one of the powertrain coolant circuit or the auxiliary coolant circuit.

L. The thermal management system of any one of example G through example K, further comprising a coolant-to-air heat exchanger in flow communication with the auxiliary coolant circuit and configured to exchange thermal energy between the auxiliary coolant circuit and the cabin refrigerant circuit.

M. The thermal management system of any one of example G through example L, further comprising a thermal storage module, and configured to store thermal energy associated with the at least one of the cooling core or the battery.

N. The thermal management system of any one of example G through example M, further comprising a four-way valve in flow communication with the powertrain coolant circuit, the auxiliary coolant circuit, and the chiller, the four-way valve configured to control one or more of flow between the powertrain coolant circuit and the auxiliary coolant circuit, flow between the chiller and the auxiliary coolant circuit, or recirculation of flow from the auxiliary coolant circuit.

O. The thermal management system of any one of example G through example N, further comprising a thermal coordinator configured to:

receive a first temperature signal indicative of a temperature associated with the powertrain coolant circuit;

receive a second temperature signal indicative of a temperature associated with the auxiliary coolant circuit; and

control, based at least in part on the first temperature signal and the second temperature signal, the four-way valve to control at least one of flow between the powertrain coolant circuit and the auxiliary coolant circuit, flow between the chiller and the auxiliary coolant circuit, or recirculation of flow from the auxiliary coolant circuit.

P. The thermal management system of any one of example G through example O, further comprising a bypass conduit in flow communication with the auxiliary coolant circuit and configured to provide flow communication between the chiller and the cooling core bypassing the coolant-to-coolant heat exchanger.

Q. An example method comprising:

flowing refrigerant through a cabin refrigerant circuit to control temperature in a cabin of a vehicle;

flowing a first coolant through an auxiliary coolant circuit to control temperature associated with auxiliary devices of the vehicle;

flowing the first coolant from the auxiliary coolant circuit and the refrigerant from the cabin refrigerant circuit through a heat exchanger to exchange thermal energy between the first coolant and the refrigerant;

flowing a second coolant through a powertrain coolant circuit configured to cool a machine; and

providing flow communication between the auxiliary coolant circuit and the powertrain coolant circuit.

R. The method of example Q, further comprising flowing the first coolant through a heat exchanger configured to exchange thermal energy between the auxiliary coolant circuit and the cabin refrigerant circuit.

S. The method of example Q or example R, further comprising:

receiving a first temperature signal indicative of a temperature associated with the first coolant;

receiving a second temperature signal indicative of a temperature associated with the second coolant; and

controlling a valve based at least in part on the first temperature signal and the second temperature signal to provide flow communication between the auxiliary coolant circuit and the powertrain coolant circuit.

T. The method of any one of example Q through example S, further comprising:

flowing the first coolant through a coolant-to-coolant heat exchanger; and

flowing the second coolant through the coolant-to-coolant heat exchanger, such that thermal energy is exchanged between the powertrain coolant circuit and the auxiliary coolant circuit.

What is claimed is:

1. A vehicle comprising:
a powertrain heating and cooling system comprising a powertrain coolant circuit, the powertrain coolant circuit comprising:
a powertrain coolant conduit configured to be in flow communication with an electric machine; and
an air-to-coolant heat exchanger in flow communication with the powertrain coolant conduit;
a cabin heating and cooling system configured to control temperature in a cabin of the vehicle, the cabin heating and cooling system comprising:
a cabin refrigerant circuit comprising a cabin refrigerant cycle configured to provide cooled air; and
a fan configured to communicate the cooled air into the cabin;
an auxiliary heating and cooling system comprising an auxiliary coolant circuit, the auxiliary coolant circuit comprising:
an auxiliary coolant conduit configured to be in flow communication with an auxiliary device; and
a chiller in flow communication with the cabin refrigerant circuit and the auxiliary coolant circuit,
wherein the chiller is configured to exchange thermal energy between the cabin refrigerant circuit and the auxiliary coolant circuit.

2. The vehicle of claim 1, further comprising an evaporator in flow communication with the cabin refrigerant circuit and configured to cool refrigerant in the cabin refrigerant circuit, wherein the evaporator is in parallel with the chiller.

3. The vehicle of claim 1, wherein the auxiliary heating and cooling system is configured to control temperature associated with at least one of a battery or a computing device.

4. The vehicle of claim 1, further comprising a valve in flow communication with the powertrain coolant circuit and the auxiliary coolant circuit, wherein the valve is configured to provide flow communication between the powertrain coolant circuit and the auxiliary coolant circuit.

5. The vehicle of claim 1, further comprising one or more of:
a coolant-to-air heat exchanger in flow communication with the auxiliary coolant circuit and configured to exchange thermal energy between the auxiliary coolant circuit and the cabin refrigerant circuit, or
a thermal storage module in flow communication with the auxiliary coolant circuit.

6. The vehicle of claim 1, further comprising a coolant-to-coolant heat exchanger in flow communication with the powertrain coolant circuit and the auxiliary coolant circuit and configured to exchange thermal energy between the powertrain coolant circuit and the auxiliary coolant circuit.

7. A thermal management system comprising:
a cabin heating and cooling system configured to control temperature in a cabin of a vehicle, the cabin heating and cooling system comprising a cabin refrigerant circuit comprising a cabin refrigerant cycle configured to cool air in communication with the cabin;
an auxiliary heating and cooling system comprising an auxiliary coolant circuit, the auxiliary coolant circuit comprising an auxiliary coolant conduit in flow communication with an auxiliary device of the vehicle;
a chiller in flow communication with the cabin refrigerant circuit and the auxiliary coolant circuit;
a powertrain heating and cooling system comprising a powertrain coolant circuit, the powertrain coolant circuit comprising a powertrain coolant conduit configured to be in flow communication with a heat source; and
a coolant-to-coolant heat exchanger in flow communication with the powertrain coolant circuit and the auxiliary coolant circuit and configured to exchange thermal energy between the powertrain coolant circuit and the auxiliary coolant circuit,
wherein the chiller is configured to exchange thermal energy between the cabin refrigerant circuit and the auxiliary coolant circuit.

8. The thermal management system of claim 7, further comprising an evaporator in flow communication with the cabin refrigerant circuit and configured to exchange thermal energy between the cabin refrigerant circuit and the auxiliary coolant circuit.

9. The thermal management system of claim 7, wherein the chiller comprises a coolant-to-refrigerant heat exchanger.

10. The thermal management system of claim 7, wherein the auxiliary heating and cooling system is configured to control temperature associated with a plurality of auxiliary devices in parallel flow communication with one another.

11. The thermal management system of claim 7, further comprising a valve in flow communication with the powertrain coolant circuit and the auxiliary coolant circuit, wherein the valve is configured to provide flow communication between the powertrain coolant circuit and the auxiliary coolant circuit based at least in part on at least one of temperature signals or pressures signals associated with at least one of the powertrain coolant circuit or the auxiliary coolant circuit.

12. The thermal management system of claim 7, further comprising a coolant-to-air heat exchanger in flow communication with the auxiliary coolant circuit and configured to exchange thermal energy between the auxiliary coolant circuit and the cabin refrigerant circuit.

13. The thermal management system of claim 12, further comprising a thermal storage module, and configured to store thermal energy associated with the at least one of the cooling core or the battery.

14. The thermal management system of claim 12, further comprising a four-way valve in flow communication with the powertrain coolant circuit, the auxiliary coolant circuit, and the chiller, the four-way valve configured to control one or more of flow between the powertrain coolant circuit and the auxiliary coolant circuit, flow between the chiller and the auxiliary coolant circuit, or recirculation of flow from the auxiliary coolant circuit.

15. The thermal management system of claim 14, further comprising a thermal coordinator configured to:
receive a first temperature signal indicative of a temperature associated with the powertrain coolant circuit;
receive a second temperature signal indicative of a temperature associated with the auxiliary coolant circuit; and
control, based at least in part on the first temperature signal and the second temperature signal, the four-way valve to control at least one of flow between the powertrain coolant circuit and the auxiliary coolant circuit, flow between the chiller and the auxiliary coolant circuit, or recirculation of flow from the auxiliary coolant circuit.

16. The thermal management system of claim 15, further comprising a bypass conduit in flow communication with the auxiliary coolant circuit and configured to provide flow communication between the chiller and the cooling core bypassing the coolant-to-coolant heat exchanger.

17. A method comprising:
flowing refrigerant through a cabin refrigerant circuit to control temperature in a cabin of a vehicle;
flowing a first coolant through an auxiliary coolant circuit to control temperature associated with auxiliary devices of the vehicle;
flowing the first coolant from the auxiliary coolant circuit and the refrigerant from the cabin refrigerant circuit through a heat exchanger to exchange thermal energy between the first coolant and the refrigerant;
flowing a second coolant through a powertrain coolant circuit configured to cool a machine; and
providing flow communication between the auxiliary coolant circuit and the powertrain coolant circuit.

18. The method of claim 17, further comprising flowing the first coolant through a heat exchanger configured to exchange thermal energy between the auxiliary coolant circuit and the cabin refrigerant circuit.

19. The method of claim 17, further comprising:
receiving a first temperature signal indicative of a temperature associated with the first coolant;
receiving a second temperature signal indicative of a temperature associated with the second coolant; and
controlling a valve based at least in part on the first temperature signal and the second temperature signal to provide flow communication between the auxiliary coolant circuit and the powertrain coolant circuit.

20. The method of claim 19, further comprising:
flowing the first coolant through a coolant-to-coolant heat exchanger; and
flowing the second coolant through the coolant-to-coolant heat exchanger, such that thermal energy is exchanged between the powertrain coolant circuit and the auxiliary coolant circuit.
